(19) United States
(12) Patent Application Publication
(10) Pub. No.: US 2025/0252352 A1
(43) Pub. Date: Aug. 7, 2025

(54) METHOD AND APPARATUS FOR GENERATING SYNTHETIC TIME SERIES

(71) Applicant: Robert Bosch GmbH, Stuttgart (DE)

(72) Inventors: Johannes Haug, Rottenburg (DE); Andreas Steimer, Schoemberg (DE); Stefan Patrick Lindt, Ettlingen (DE); Timo Pfrommer, Stuttgart (DE)

(21) Appl. No.: 19/043,668

(22) Filed: Feb. 3, 2025

(30) Foreign Application Priority Data
Feb. 7, 2024 (DE) 10 2024 201 096.0

(51) Int. Cl. G06N 20/00

(52) U.S. Cl. CPC G06N 20/00

(57) ABSTRACT

A method for generating synthetic time series for augmenting a training data set of training time series used for training a machine learning model.

### CROSS REFERENCE

The present application claims the benefit under 35 U.S.C. § 119 of German Patent Application No. DE 10 2024 201 096.0 filed on Feb. 7, 2024, which is expressly incorporated herein by reference in its entirety.

### FIELD

The present invention relates to a method and an apparatus for generating synthetic time series for augmenting a training data set of training time series used for training a machine learning model. The present invention further relates to a method for training a machine learning model. The present invention also relates to an inference method. The present invention further relates to a control unit. The present invention also relates to a computer program and to a computer-readable data carrier.

### BACKGROUND INFORMATION

At the heart of modern manufacturing processes is the generation and analysis of data, which is crucial for maintaining product quality and the efficiency of production lines. Time series data, which are detected during the manufacturing processes and provide in-depth insights into the production dynamics, play a special role here.

However, a critical aspect of this data is its tendency towards unbalanced labels, wherein the category “OK” for defect-free processes or parts occurs significantly more frequently than “NOK” for defective processes or parts. This disproportion causes traditional classification and anomaly recognition models trained on these time series to develop a bias in favor of the overrepresented class, which affects the precision and reliability of the models.

To overcome these challenges, the synthetic generation of time series data is becoming increasingly important. This method aims to create a balance in the training data sets by learning and emulating the characteristic features of real time series data, thereby increasing model performance.

Of particular note are the technologies based on neural networks, which currently represent the related art in the generation of synthetic time series. Specialized generative adversarial networks (GANs) such as TimeGAN and DoppelGanger along with probabilistic approaches such as the probabilistic autoregressive model (PAR) are at the heart of these methods to effectively address the challenges of unbalanced time series data in the manufacturing industry.

Even if approaches for generating synthetic time series are already available, there is still potential for further development.

### SUMMARY

An object of the present invention is to provide an improved method and/or an improved apparatus for generating synthetic time series.

The object may be achieved by a method for generating synthetic time series for augmenting a training data set of training time series according to certain features of the present invention. The object may be achieved by a method for training a machine learning model according to certain features of the present invention. The object may be achieved by an inference method according certain features of the present invention. The object may be achieved by a control unit according to certain features of the present invention. The object may be achieved by an apparatus for generating synthetic time series for augmenting a training data set of training time series according to certain features of the present invention.

According to a first aspect of the present invention, a method for generating synthetic time series for augmenting a training data set of training time series used for training a machine learning model is provided. According to an example embodiment of the present invention, the method for generating comprises the following steps:
providing a time series density matrix, which is extracted from the training time series on the basis of time series shift paths generated by a dynamic time warping algorithm;
providing a master time series shift path on the basis of the time series shift paths;
providing a reference time series on the basis of the training time series;
generating a synthetic time series shift path by means of iteratively performing the following steps:
starting from a particular starting position in the time series density matrix, which preferably corresponds to a particular starting position of the synthetic time series shift path, ascertaining probabilities on the basis of the time series density matrix of next possible positions of the synthetic time series shift path;
identifying the position of the next possible positions with which the distance to the master time series shift path is minimized;
changing the ascertained probabilities of the next possible positions of the synthetic time series shift path to be generated on the basis of a predetermined hyperparameter of the master time series shift path;
setting a next position of the synthetic time series shift path by randomly selecting a position from the changed, next possible positions;
generating a synthetic time series from the synthetically generated time series shift path and the reference time series for augmenting the training data set of training time series.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, an apparatus for generating synthetic time series for augmenting a training data set of training time series used for training a machine learning model is provided. According to an example embodiment of the present invention, the apparatus comprises an evaluation and computing device which is formed to execute the following steps:
providing a time series density matrix, which is extracted from the training time series on the basis of time series shift paths generated by a dynamic time warping (DTW) algorithm;
providing a master time series shift path on the basis of the time series shift paths;
providing a reference time series on the basis of the training time series;
generating a synthetic time series shift path by means of iteratively performing the following steps:
starting from a particular starting position in the time series density matrix, which preferably corresponds to a particular starting position of the synthetic time series shift path, ascertaining probabilities on the basis of the time series density matrix of next possible positions of the synthetic time series shift path;
identifying the position of the next possible positions with which the distance to the master time series shift path is minimized; changing the ascertained probabilities of the next possible positions of the synthetic time series shift path to be generated on the basis of a predetermined hyperparameter of the master time series shift path;
setting a next position of the synthetic time series shift path by randomly selecting a position from the changed, next possible positions;
generating a synthetic time series from the synthetically generated time series shift path and the reference time series for augmenting the training data set of training time series.

The explanations given for the method of the present invention apply accordingly to the apparatus of the present invention. It is understood that linguistic modifications of features formulated for the method can be reformulated for the apparatus in accordance with standard linguistic practice, without such formulations having to be explicitly listed here.

The present invention relates to a method for generating synthetic time series that can subsequently be used, for example, in order to train an anomaly detector. According to an example embodiment of the present invention, it is provided that the DTW algorithm is used to obtain a matrix representation of time series. The synthetic time series are then preferably sampled from the matrix representation.

Dynamic time warping (DTW) is an algorithm used to measure similarities between temporal sequences/time series, which may differ in speed or length. The elements of two time series are adapted to one another in such a way that the sum of the distances between paired elements is minimized. This distinguishes DTW from other distance measures such as the Euclidean distance, which assumes a strict one-to-one assignment between the points in the sequences and thus does not tolerate any temporal shift or elongation between the sequences. First, DTW creates a matrix in which the rows and columns correspond to the elements of the two time series. Each element of the matrix represents the distance between the points of the two sequences. The distances between each pair of points in the two time series are calculated (often using Euclidean distance) and entered into the matrix. DTW runs through the matrix in order to find the route/path with the shortest cumulative distance. This path represents the best assignment between the points in the two time series. The route/path is selected so that each point in each sequence is assigned at least once, and the assignment minimizes the total distance. Optionally, the cumulative distance is divided by the number of steps in the path, in order to normalize sequence length effects. One advantage of DTW is its flexibility in dealing with time series that differ in length or are shifted in time.

The method for generating synthetic time series can also be understood as a method for training the DTW algorithm. Synthetic time series can then be generated on the basis of the trained DTW algorithm. Preferably, a large number of time series are generated with the present method. The time series shift path can also be understood as a time series distortion path or a time series curvature path.

According to an example embodiment of the present invention, the method preferably starts at the index position (0,0) of the time series density matrix as the initial starting position for generating a particular synthetic time series shift path. Based on this, a new time series shift path is then scanned iteratively (per index position), in particular until a certain size and/or a termination criterion is reached.

In order to generate synthetic time series, new 2D representations of time series shift paths are derived from the time series density matrix within the framework of the present invention. With the aid of a reference time series, the sampled 2D representations of the time series shift paths can then be transformed back into the original (one-dimensional or multi-dimensional) time series space. The proposed DTW-based approach for generating synthetic time series is more efficient and interpretable than existing approaches for generating synthetic time series.

The present invention may mitigate certain disadvantages of the related art in neural networks for generating time series, including their high resource consumption, their sensitivity to hyperparameters and their lack of interpretability. The presented method of the present invention for generating synthetic time series uses an efficient open-source implementation of the dynamic time warping algorithm. The generation itself is carried out only on the basis of a set of 2D representations of time series shift paths. This requires minimal memory and computational power. Further, the method can generate realistic, synthetic time series with a fraction of the training data required by neural networks. Accordingly, the method is more efficient than the approaches for generating synthetic time series data by means of existing deep neural networks. The method for generating preferably requires only a small number of hyperparameters, in particular those specified by a user. The method also uses a simple (deterministic) algorithm for creating synthetic time series from a sampled 2D representation of time series shift paths. The proposed approach is therefore interpretable.

According to an example embodiment of the present invention, the method for generating synthetic time series data is an upstream part of the machine learning tool chain. It does not directly improve a machine learning system that can be used for the applications mentioned below, but is a generative model for creating and augmenting training and/or test data. Once the machine learning model has been trained in this way, it can subsequently be used in an optimized manner.

In one example embodiment of the present invention, providing the time series density matrix comprises:
calculating a particular time series shift path between the reference time series and the particular training time series on the basis of the dynamic time warping algorithm; and
aggregating the calculated time series shift paths to the time series density matrix.

The time series shift path is preferably calculated for each time series of the training time series or at least for a part of the time series of the training time series. The present method uses dynamic time warping (DTW) for calculating the particular time shift path between each training time series and a reference time series. The particular time shift path preferably defines the set of index pairs that describes the best possible match between the particular training time series and the reference time series in terms of similarity. In particular, dynamic time warping (DTW) identifies the nearest corresponding indices in the reference time series for each index in a (training) time series. A time series shift path can be represented/mapped by a 2D matrix that contains “1” in each field that corresponds to an index match, and “0” otherwise.

The time series density matrix, which represents the density of the time shifts in the training data, can be ascertained by aggregating or adding the 2D time shift matrices of the time shift paths of the analyzed training time series. The time series density matrix describes the time-warping characteristics of the training set. New, synthetic time shift paths can then be derived iteratively from this time series density matrix. The synthetic time shift paths are then used for generating synthetic time series.

In one example embodiment of the present invention, weighting of the time series shift paths is carried out prior to aggregation.

The weights can, for example, be set by a user or determined in another way.

In one example embodiment of the present invention, the reference time series can be selected by a user from the training time series or another time series data set, or can be extracted from the training time series, in particular by averaging over at least a part of the training time series, or can be ascertained by calculating a barycenter of at least a part of the training time series to serve as a reference.

The barycenter is preferably a hypothetical and/or synthetic time series that minimizes the DTW distance to all training time series. The reference time series can also be provided in other ways, for example on the basis of historical data.

In one example embodiment of the present invention, the master time series shift path is randomly selected from the time series shift paths.

The random criterion used to decide this is arbitrary in principle. An extraction of a random time shift path is thus carried out from the training data set, which is intended to serve as a “guide” for generating the synthetic time series shift paths.

In one example embodiment of the present invention, the iterative performance is carried out until a termination criterion is reached, in particular a predetermined path size and/or path length of the time series shift path to be generated synthetically.

In principle, a number of iterations can also serve as a termination criterion. Alternatively or additionally, a length of the reference time series can also serve as a termination criterion.

In one example embodiment of the present invention, the ascertainment of probabilities on the basis of the time series density matrix of next possible positions of the synthetic time series shift path comprises: On the basis of the starting position in the time series density matrix, ascertaining the Markov probabilities of the next possible positions, in particular by dividing the corresponding count values in the time series density matrix by their respective sums.

According to an example embodiment of the present invention, preferably, the Markov probability of the possible next positions is ascertained based on the current position (varying per iteration step) in the time series density matrix, whereby the probability of the possible next position is ascertained for a step to the right, for a step upwards and/or for a step along the diagonal starting from the particular starting position. This is done in particular by dividing the corresponding count values in the time series density matrix by their sum.

In one example embodiment of the present invention, the hyperparameter comprises a sample temperature of the master time series shift path, which can be specified in particular by a user.

The sample temperature describes a hyperparameter that describes the randomness of the sampling trajectory of the master time series shift path. The sample temperature is preferably set to less than 1. Further, identifying a possible next step that is closest to the sampled master time series shift path is preferably carried out. Changing the probabilities is preferably carried out according to the set sample temperature. If the sample temperature is 0, the newly generated time series shift path then preferably follows the master time series shift path exactly. The sample temperature is preferably set to approximately 0.5.

In one example embodiment of the present invention, generating the synthetic time series from the synthetically generated time series shift path and the reference time series comprises: matching discrete time series values of the reference time series with a particular index position of the synthetically generated time series shift path for generating a particular discrete, synthetically generated time series value; and optionally interpolating missing values and/or smoothing the synthetic time series generated on the basis of the discrete, synthetic time series value.

For each position in the synthetically generated time series shift path, an appending of the corresponding value from the reference time series to the new time series is preferably carried out. If a position of the synthetically generated time series shift path is linked to a plurality of values from the reference time series, their mean value is preferably appended to the time series to be generated. In this way, no information is lost from the reference time series. If a plurality of positions of the synthetically generated time series shift path are associated with the same value of the reference time series, the value is preferably only appended once to the time series to be generated and a non-assigned value (NaN) is set at the remaining positions. If the same value of the reference time series were to be repeatedly appended to the time series to be generated, the synthetic time series to be generated would look like a step function (i.e., it would have a plurality of plateaus), since dynamic time warping leads to discrete position matches. This must be avoided. Interpolation is particularly preferably performed for the NaN values. Preferably, a smoothing window of a predetermined size can also be applied. In this way, an interpolated and/or smoothed synthetic time series can be provided.

According to an example embodiment of the present invention, in the present case, a method for training a machine learning model for classification or anomaly recognition, particularly in production processes, is also provided. The method having the following steps:
providing an augmented training data set of training time series augmented by synthetically generated time series according to the present method for generating synthetic time series; training the machine learning model on the basis of the augmented training data set; and
providing the trained machine learning model for classification or anomaly recognition, in particular in production processes.

The provided algorithm according to the present invention can be trained in a monitored and unmonitored manner. In the monitored training scenario, the steps are preferably performed independently for each class.

An inference method for classification or anomaly recognition, in particular in production processes, is also claimed in the present case. The inference method comprises the following steps: providing time series data that are detected by a sensor; and classifying the provided time series data and/or recognizing anomalies in the provided time series data using a machine learning model trained in the present case.

The inference method of the present invention can also be used to analyze sensor data. A sensor can detect measurements of the environment in the form of sensor signals. These sensor signals can comprise one-dimensional or multi-dimensional time series, for example from a repeatable process (e.g., a pressing or screwing process).

The inference method of the present invention and/or method for generating of the present invention can also be used to recognize anomalies in a technical system. For example, synthetic time series can be generated to augment an existing data set of time series in order to enlarge the data set and/or make it more balanced (e.g., “OK”/“NOK” time series). Training the machine learning model for recognizing anomalies on the basis of the augmented data set leads to improved model performance compared to training only on the basis of the originally detected time series.

Also provided according to the present invention is a control unit, which is comprised for a semi-automated or automated driving function of a motor vehicle and/or a drone and/or in a robotic system and/or in an industrial machine and/or is used for optical inspection, and on which a machine learning model trained according to the present invention is executable.

The method for generating synthetic time series according to the present invention can be useful wherever a machine learning time series model suffers from unbalanced training data. The method for generating synthetic time series of the present invention is particularly preferable for the recognition of anomalies in production processes that, for example, comprise time series sensor data, such as purely exemplary temperature data, pressure data, force data and/or torque data, having a discrepancy between “OK” and “NOK” portions (anomalies). Conventional machine learning models for recognizing anomalies tend to overlook the differences between “OK” and “NOK” in time series, in particular if the models are trained on “OK” instances. The present method for generating synthetic time series can counteract this behavior, since synthetic time series can be generated in order to obtain a more balanced training set of training time series (which also covers NOK, for example) and thus improve the generalization capabilities in anomaly recognition. The same advantage also applies to the classification of time series, e.g. if a distinction is to be made between more or less frequent error types. Due to the present method for generating synthetic time series, an overfitting when training machine learning models can be prevented.

The method for generating synthetic time series according to the present invention is also useful for augmenting training data sets from the real world if, for example, data detection is (structurally) technically complex and/or expensive. For example, it may not be possible to provide extensive time series data, e.g., from a mobile smart device or a smart home device, for data protection reasons. Due to the present method for generating synthetic time series, a small data set can be augmented and used for training a model. Similarly, transmitting vehicle sensor measurements via the cloud can be expensive in order to collect training data in large sets. Due to the present method for generating synthetic time series, a small data set can be augmented and used for training a model. The present method for generating synthetic time series is able to generate synthetic time series on the basis of only a few time series. It is preferable that the output time series available for generation make a realistic 2D time shift representation possible. This is an advantage of the present invention, since conventional approaches based on neural networks, for example, require large sets of training data in order to generate realistic synthetic time series.

In the present case, the present invention also provides a computer program having program code to execute at least parts of the method according to the present invention in one of its embodiments when the computer program is executed on a computer. In other words, according to the present invention, a computer program (product) comprising commands that, when the program is executed by a computer, cause the computer to carry out the method/steps of the method according to the present invention in any of its embodiments.

The present invention also provides a computer-readable data carrier having program code of a computer program to execute at least parts of the method according to the present invention in one of its embodiments when the computer program is executed on a computer. In other words, the present invention relates to a computer-readable (memory) medium comprising commands that, when executed by a computer, cause the computer to perform the method/steps of the method according to the present invention in one of its embodiments.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of an example embodiment of the method for generating synthetic time series, according to the present invention.

FIG. 2 is a schematic representation of an ascertainment of a time-warping path, according to an example embodiment of the present invention.

FIG. 3 is a schematic representation of an ascertainment of a time series density matrix, according to an example embodiment of the present invention.

FIG. 4 is a schematic flow chart for generating a synthetic time-warping path, according to an example embodiment of the present invention.

FIG. 5 is a schematic representation for generating a synthetic time series from a synthetic time warping path, according to an example embodiment of the present invention.

### DETAILED DESCRIPTION OF EXAMPLE EMBODIMENTS

In the figures, identical reference signs denote identical or functionally identical elements, parts or components, unless stated otherwise.

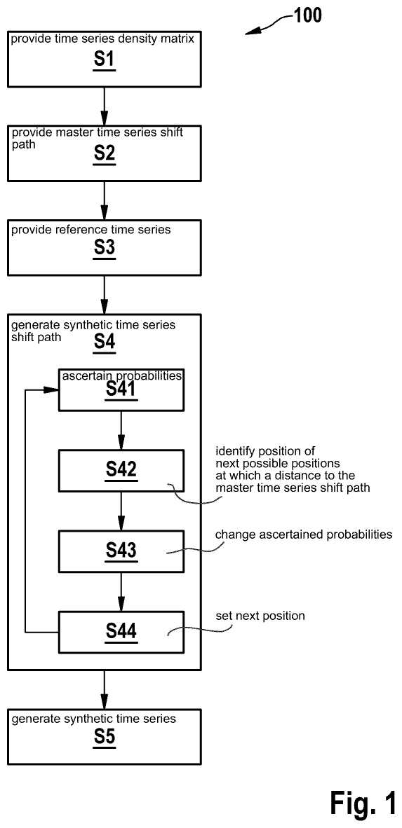

FIG. 1 shows a schematic flow chart of a method for generating synthetic time series for augmenting a training data set of training time series that is used for training a machine learning model.

In any embodiment, the method can be carried out at least partially by an apparatus 100 that can comprise, for this purpose, multiple components (not represented in detail), for example one or more provision devices and/or at least one evaluating and computing device. It is self-evident that the provisioning device can be designed together with the evaluation and computing device, or can be different therefrom. Further, the apparatus can comprise a storage device and/or an output device and/or a display device and/or an input device.

According to the present invention, the computer-implemented method comprises at least the following steps:

In step S1, the provision of a time series density matrix is carried out, which is extracted from the training time series on the basis of time series shift paths generated by a dynamic time warping algorithm.

In step S2, the provision of a master time series shift path is carried out on the basis of the time series shift paths.

In step S3, the provision of a reference time series is carried out on the basis of the training time series;

In a step S4, the generation of a synthetic time series shift path is carried out by means of iteratively performing the following steps.

In a step S41, starting from a particular starting position in the time series density matrix, which preferably corresponds to a particular starting position of the synthetic time series shift path, the ascertainment of probabilities is carried out on the basis of the time series density matrix of next possible positions of the synthetic time series shift path.

In a step S42, the identification of the position of the next possible positions with which a distance to the master time series shift path is minimized is carried out.

In a step S43, the changing of the ascertained probabilities of the next possible positions of the synthetic time series shift path to be generated is carried out on the basis of a predetermined hyperparameter of the master time series shift path.

In a step S44, the setting of a next position of the synthetic time series shift path is carried out by randomly selecting a position from the changed, next possible positions.

In step S5, the generation of a synthetic time series from the synthetically generated time series shift path and the reference time series is carried out for augmenting the training data set of training time series.

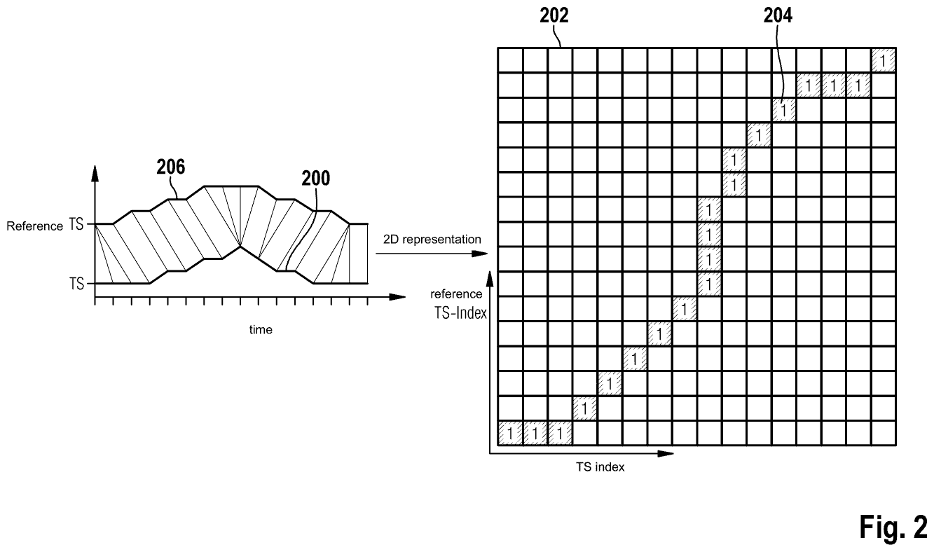

FIG. 2 shows a schematic representation of a transfer of a training time series 200 into a 2D matrix representation 202 of a time series shift path 204 by a dynamic time warping algorithm. The time series shift path 204 is calculated on the basis of the dynamic time warping algorithm between a reference time series 206 and the training time series 200. A time series shift path can be represented/mapped by the 2D matrix 202 that contains “1” in each field that corresponds to an index match between the reference time series 206 and the training time series 200, and “0” (not represented or left blank) otherwise.

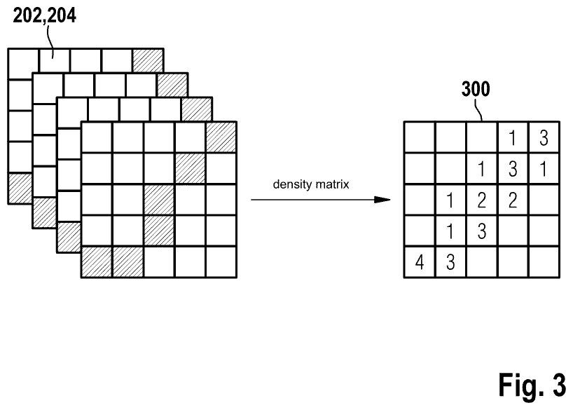

FIG. 3 shows a schematic representation for generating a time series density matrix 300. After the particular 2D matrix representation 202 of the particular time series shift path 204 is available for each or at least a subset of the training time series 200, the 2D matrix representations 202 of the calculated time series shift paths 204 are aggregated or summed to form the time series density matrix 300.

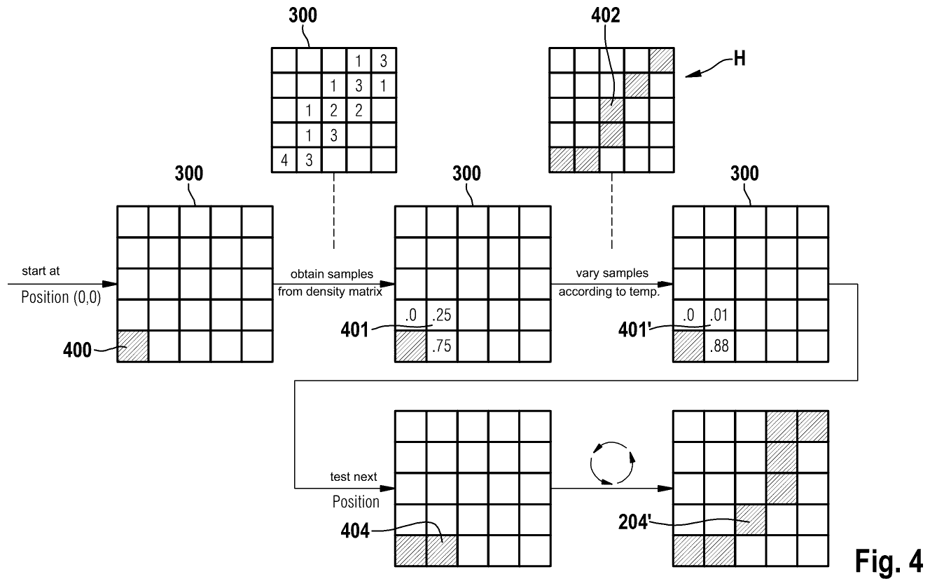

FIG. 4 shows how a synthetic time series shift path 204′ is generated on the basis of the density matrix. Starting from a particular starting position 400, at the beginning the position (0,0) in the time series density matrix 300, which preferably also corresponds to a starting position of the later, synthetic time series shift path 204′, probabilities 401 are ascertained on the basis of the time series density matrix 300 of next possible positions of the synthetic time series shift path 204′. Further, the position of the next possible positions at which a distance to a master time series shift path 402 is minimized is then identified. Further, the changing of the ascertained probabilities 401 to 401′ of the next possible positions of the synthetic time series shift path 204′ to be generated is carried out on the basis of a predetermined hyperparameter H of the master time series shift path. A next position 404 of the synthetic time series shift path 204′ is set by randomly selecting a position from the changed, next possible positions. The iterative performance is then carried out until a termination criterion is reached, in particular a predetermined path size and/or path length of the time series shift path 204′ to be generated synthetically.

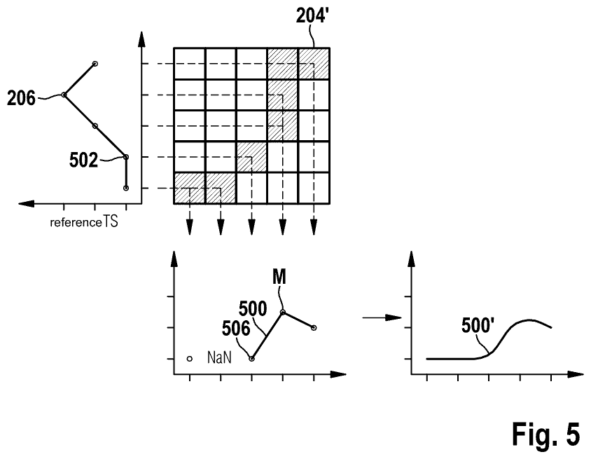

FIG. 5 shows how a synthetic time series 500 can be generated from the synthetically generated time series shift path 204′ and the reference time series 206. A matching of discrete time series values 502 of the reference time series 206 with a particular index position 504 of the synthetically generated time series shift path 204′ is carried out for generating a particular discrete, synthetically generated time series value 506. Optionally, an interpolation of missing values and/or a smoothing of the synthetic time series 500 generated on the basis of the discrete, synthetic time series value 506 can also be performed. An interpolated and/or smoothed synthetic time series 500′ can then preferably be provided in this way. For each position in the synthetically generated time series shift path 204′, an appending of the corresponding value 502 from the reference time series 206 to the new time series 500 is preferably carried out. If a position of the synthetically generated time series shift path 204′ is linked to a plurality of values 502 from the reference time series 206, their mean value M is preferably appended to the time series 500 to be generated. In this way, no information is lost from the reference time series 206. If a plurality of positions of the synthetically generated time series shift path 204′ are associated with the same value 502 of the reference time series 206, the value is preferably only appended once to the time series 500 to be generated and a non-assigned value (NaN) is set at the remaining positions. Interpolation is particularly preferably performed for the NaN values. Preferably, a smoothing window of a predetermined size can also be applied.

What is claimed is:

1. A method for generating synthetic time series for augmenting a training data set of training time series used for training a machine learning model, the generating method comprising the following steps:
providing a time series density matrix which is extracted from the training time series based on time series shift paths generated by a dynamic time warping algorithm;
providing a master time series shift path based on the the time series shift paths;
providing a reference time series based on the training time series;
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of the next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions;
generating a synthetic time series from the synthetically generated time series shift path and the reference time series for augmenting the training data set of training time series.

2. The method according to claim 1, wherein the providing of the time series density matrix includes:
calculating each time series shift path between the reference time series and the training time series based on the dynamic time warping algorithm; and
aggregating the calculated time series shift paths to the time series density matrix.

3. The method according to claim 2, wherein weighting of the time series shift paths is carried out prior to aggregation.

4. The method according to claim 1, wherein the reference time series is selected by a user from the training time series or another time series data set, or is extracted from the training time series by averaging over at least a part of the training time series, or is ascertained by calculating a barycenter of at least a part of the training time series.

5. The method according to claim 1, wherein the master time series shift path is randomly selected from the time series shift paths.

6. The method according to claim 1, wherein the iterative performance is carried out until a termination criterion is reached, including a predetermined path size and/or path length of the time series shift path to be generated synthetically.

7. The method according to claim 1, wherein the ascertainment of the probabilities based on the time series density matrix of the next possible positions of the synthetic time series shift path includes: based on the starting position in the time series density matrix, ascertaining Markov probabilities of the next possible positions by dividing corresponding count values in the time series density matrix by their respective sums.

8. The method according to claim 1, wherein the hyperparameter includes a sample temperature of the master time series shift path, which is specifiable by a user.

9. The method according to claim 1, wherein the generating of the synthetic time series from the synthetically generated time series shift path and the reference time series includes:
matching discrete time series values of the reference time series with a particular index position of the synthetically generated time series shift path for generating a particular discrete, synthetically generated time series value; and
optionally interpolating missing values and/or smoothing the synthetic time series generated based on the the discrete, synthetically generated time series value.

10. A method for training a machine learning model for classification or anomaly recognition, the method comprising the following steps:
providing an augmented training data set of training time series, which is augmented by synthetically generated time series, the synthetically generated time series being generated by:
providing a time series density matrix which is extracted from the training time series based on time series shift paths generated by a dynamic time warping algorithm,
providing a master time series shift path based on the the time series shift paths,
providing a reference time series based on the training time series,
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of the next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions, and
generating the synthetic time series from the synthetically generated time series shift path and the reference time series for augmenting the training data set of training time series;
training the machine learning model based on the augmented training data set; and
providing the trained machine learning model for classification or anomaly recognition in the production process.

11. An inference method for classification or anomaly recognition, comprising the following steps:
providing time series data that are detected by a sensor; and
classifying the provided time series data or recognizing anomalies in the provided time series data using a machine learning model trained by:
providing an augmented training data set of training time series, which is augmented by synthetically generated time series, the synthetically generated time series being generated by:
providing a time series density matrix which is extracted from the training time series based on time series shift paths generated by a dynamic time warping algorithm,
providing a master time series shift path based on the the time series shift paths,
providing a reference time series based on the training time series,
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of the next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions, and
generating the synthetic time series from the synthetically generated time series shift path and the reference time series for augmenting the training data set of training time series; and
training the machine learning model based on the augmented training data set.

12. A control unit for an automated driving function of a motor vehicle, an automated function of a drone, a robot and/or for an automated optical inspection of components and/or samples, the control unit being configured to classification or anomaly recognition, the control unit configured to:
provide time series data that are detected by a sensor; and
classify the provided time series data for recognizing anomalies in the provided time series data using a machine learning model trained by:
providing an augmented training data set of training time series, which is augmented by synthetically generated time series, the synthetically generated time series being generated by:
providing a time series density matrix which is extracted from the training time series based on time series shift paths generated by a dynamic time warping algorithm,
providing a master time series shift path based on the the time series shift paths,
providing a reference time series based on the training time series,
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of the next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions, and
generating the synthetic time series from the synthetically generated time series shift path and the reference time series for augmenting the training data set of training time series; and
training the machine learning model based on the augmented training data set.

13. An apparatus configured to generating synthetic time series for augmenting a training data set of training time series used for training a machine learning model, the apparatus comprising an evaluation and/or computing device adapted to execute the following steps:
providing a time series density matrix, which is extracted from the training time series based on time series shift paths generated by a dynamic time warping algorithm;
providing a master time series shift path based on the time series shift paths;
providing a reference time series based on the training time series;
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions;
generating a synthetic time series from the synthetically generated time series shift path and the reference time series for augmenting the training data set of training time series.

14. A non-transitory computer-readable data carrier on which is stored program code of a computer program to execute at least parts of a method for generating synthetic time series for augmenting a training data set of training time series used for training a machine learning model, the program code, when executed by a computer causing the computer to perform at least some of the following steps of the method:
providing a time series density matrix which is extracted from the training time series based on time series shift paths generated by a dynamic time warping algorithm;
providing a master time series shift path based on the the time series shift paths;
providing a reference time series based on the training time series;
generating a synthetic time series shift path by iteratively performing the following steps:
starting from a particular starting position in the time series density matrix, which corresponds to a particular starting position of the synthetic time series shift path, ascertaining probabilities based on the time series density matrix of next possible positions of the synthetic time series shift path,
identifying a position of the next possible positions with which a distance to the master time series shift path is minimized,
changing the ascertained probabilities of the next possible positions of the synthetic time series shift path to be generated based on a predetermined hyperparameter of the master time series shift path, and
setting a next position of the synthetic time series shift path by randomly selecting a position from the changed, next possible positions;
generating a synthetic time series from the synthetically generated time series shift path and the reference time series for augmenting the training data set of training time series.
